(19) United States
(12) Patent Application Publication
(10) Pub. No.: US 2013/0202160 A1
(43) Pub. Date: Aug. 8, 2013

(54) INFORMATION PROCESSING TERMINAL, RECOGNITION CONTROL METHOD FOR THE SAME, AND RECOGNITION CONTROL PROGRAM

(71) Applicant: Hitachi Consumer Electronics Co., Ltd., Tokyo (JP)

(72) Inventor: Kazuhiko YOSHIZAWA, Yokohama (JP)

(73) Assignee: HITACHI CONSUMER ELECTRONICS CO., LTD., Tokyo (JP)

(21) Appl. No.: 13/742,637

(22) Filed: Jan. 16, 2013

(30) Foreign Application Priority Data
Feb. 6, 2012 (JP) 2012-022647

(51) Int. Cl. G06K 9/00

(52) U.S. Cl. CPC G06K 9/00228
USPC 382/118

(57) ABSTRACT

An information processing terminal capable of imposing restrictions on a predetermined function includes an image input unit capable of inputting a facial image of a recognition object person, a facial image storage unit for storing a facial image of a recognition registrant, a concordance rate detection unit for detecting a concordance rate between the facial image of the recognition object person and the facial image of the recognition registrant, a restriction cancel unit for canceling the restrictions on the predetermined function on the basis of the concordance rate detected by the concordance rate detection unit, a display unit capable of displaying information, and a display control unit for controlling to display information concerning the concordance rate on the display unit concurrently with the facial image of the recognition object person.

### INCORPORATION BY REFERENCE

The present application claims priority from Japanese application JP2012-022647 filed on Feb. 6, 2012, the content of which is hereby incorporated by reference into this application.

### BACKGROUND OF THE INVENTION

The present invention relates to an information processing terminal, its recognition control method, and a recognition control program.

In recent years, spread of portable information processing terminals such as portable telephones and smart phones has advanced and a large number of people have had portable information processing terminals. Furthermore, as the hardware evolves, the portable information processing terminals become capable of holding a large amount of individual information and become equipped with a money transaction function using the electronic money function. Therefore, greater fears are entertained as to individual information leakage and a financial damage due to use by a third person without permission compared with what it was. And in general, the portable information processing terminals have a terminal lock function. As the method for setting/canceling the terminal lock function, a method using a PIN (Personal Identification Number) input or a pass word input is adopted frequently under the existing circumstances. In recent years, however, a method using facial recognition has also been proposed.

When applying a facial recognition function to an information processing terminal, a facial image of a recognition registrant (an owner of the information processing terminal) is previously stored in a memory within the information processing terminal. When conducting recognition processing, it is ascertained whether a recognition object person is the recognition registrant by comparing and collating a facial image of the recognition object person picked up by a camera or the like in the information processing terminal with the facial image of the recognition registrant stored in the memory.

In the facial recognition, however, fears are entertained as to a possibility of failing in recognition even if the recognition object person is the recognition registrant. Because when picking up a facial image of the recognition object person by using a camera or the like in the information processing terminal at the time of recognition processing, a necessary concordance rate might not be obtained in the comparative collation with the facial image of the recognition registrant stored in the memory within the information processing terminal under the influence of brightness around the recognition object person, direction of the face with respect to the camera or the like, a slight change of the expression, or the like. As a technique for preventing such a recognition failure, for example, there is a technique described in JP-A-2005-115481.

### SUMMARY OF THE INVENTION

In the technique described in JP-A-2005-115481, facial image of a recognition registrant photographed under a plurality of different environments are stored as a database and a 1:N collation is conducted between a facial image obtained by photographing a recognition object person at time of recognition processing and a plurality of facial images stored in the database. It is conducted with consideration to avoid failing in recognition under the influence of brightness around the recognition object person, direction of the face with respect to the camera or the like, a slight change of the expression, or the like.

In the technique described in JP-A-2005-115481, however, it is necessary to prepare facial images of the recognition registrant photographed under a plurality of different environments, when registering facial images of the recognition registrant, resulting in complicated registration processing. In addition, there is a problem that a required capacity of a memory for storing images for facial recognition within the information processing terminal also becomes large.

In view of the problems, an object of the present invention is to provide an information processing terminal having a more useful recognition function, its recognition control method, and a recognition control program.

As a measure for solving the problems, the present invention uses configurations described in claims.

For example, an information processing terminal capable of imposing restrictions on a predetermined function is used. The information processing terminal includes an image input unit capable of inputting a facial image of a recognition object person, a facial image storage unit for storing a facial image of a recognition registrant, a concordance rate detection unit for detecting a concordance rate between the facial image of the recognition object person which is input by the image input unit and the facial image of the recognition registrant stored in the facial image storage unit, a restriction cancel unit for canceling the restrictions on the predetermined function on the basis of the concordance rate detected by the concordance rate detection unit, a display unit capable of displaying information, and a display control unit for exercising display control on the display unit. And the display control unit exercises control to display information concerning the concordance rate detected by the concordance rate detection unit on the display unit concurrently with the facial image of the recognition object person which is input by the image input unit.

According to the present invention, it becomes possible to provide an information processing terminal having a more useful recognition function, its recognition control method, and a recognition control program.

Other objects, features and advantages of the invention will become apparent from the following description of the embodiments of the invention taken in conjunction with the accompanying drawings.

### BRIEF DESCRIPTION OF THE DRAWINGS

FIG. 1 is a block diagram of an information processing terminal according to an embodiment;

FIG. 2 is an exterior view of an information processing terminal according to an embodiment;

FIG. 3 is a configuration diagram of a communication system including an information processing terminal according to an embodiment;

FIG. 4 is a flow chart at time of operation acceptance of an information processing terminal according to an embodiment;

FIG. 5 is a flow chart at time of terminal lock control of an information processing terminal according to an embodiment;

FIG. 6 shows screen display views of an information processing terminal according to an embodiment;

FIG. 7 is a flow chart at time of terminal unlock processing of an information processing terminal according to an embodiment;

FIG. 8 shows screen display views of an information processing terminal according to an embodiment;

FIG. 9 shows screen display views of an information processing terminal according to an embodiment;

FIG. 10 shows screen display views of an information processing terminal according to an embodiment;

FIG. 11 shows screen display views of an information processing terminal according to an embodiment;

FIG. 12 shows screen display views of an information processing terminal according to an embodiment;

FIG. 13 is a flow chart at time of facial similarity confirmation processing of an information processing terminal according to an embodiment; and

FIG. 14 shows screen display views of an information processing terminal according to an embodiment.

### DESCRIPTION OF THE EMBODIMENTS

Hereafter, embodiments of the present invention will be described with reference to the drawings.

### Embodiment 1

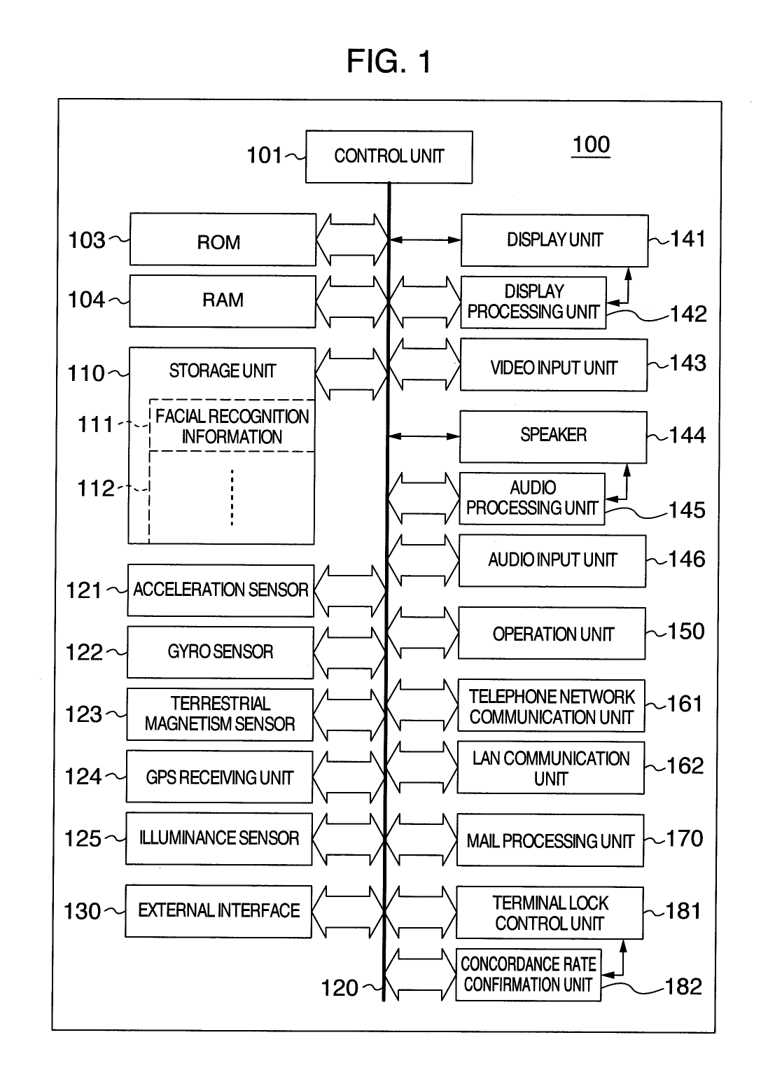

FIG. 1 is an example of a block diagram of a portable information processing terminal according to the present invention. A portable information processing terminal 100 includes a control unit 101, a system bus 102, a ROM 103, a RAM 104, a storage unit 110, an acceleration sensor 121, a gyro sensor 122, a terrestrial magnetism sensor 123, a GPS receiving unit 124, an illuminance sensor 125, an external interface 130, a display unit 141, a display processing unit 142, a video input unit 143, a speaker 144, a audio processing unit 145, a audio input unit 146, an operation unit 150, a telephone network communication unit 161, a LAN communication unit 162, a mail processing unit 170, a terminal lock control unit 181, and a concordance rate confirmation unit 182.

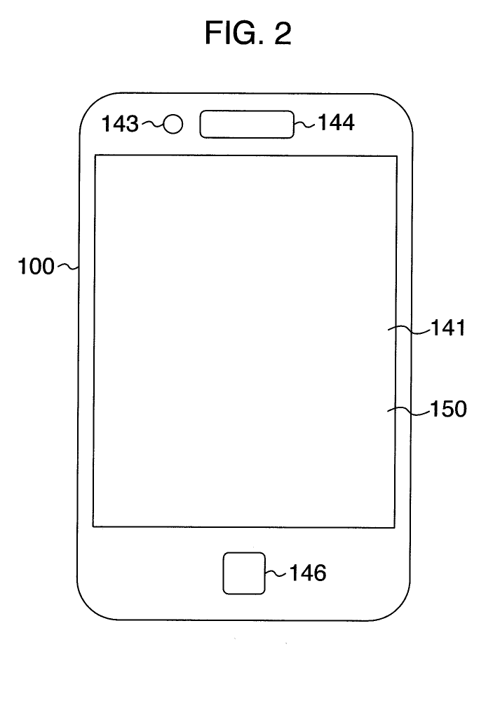

An example of an exterior view of the portable information processing terminal 100 is shown in FIG. 2. In FIG. 2, a unit having the same reference numeral as that in FIG. 1 has a configuration/function like that of the corresponding unit in FIG. 1. By the way, in the exterior view shown in FIG. 2, only representative configurations which will be described in detail in the ensuing description are shown, and other configurations are omitted in illustration.

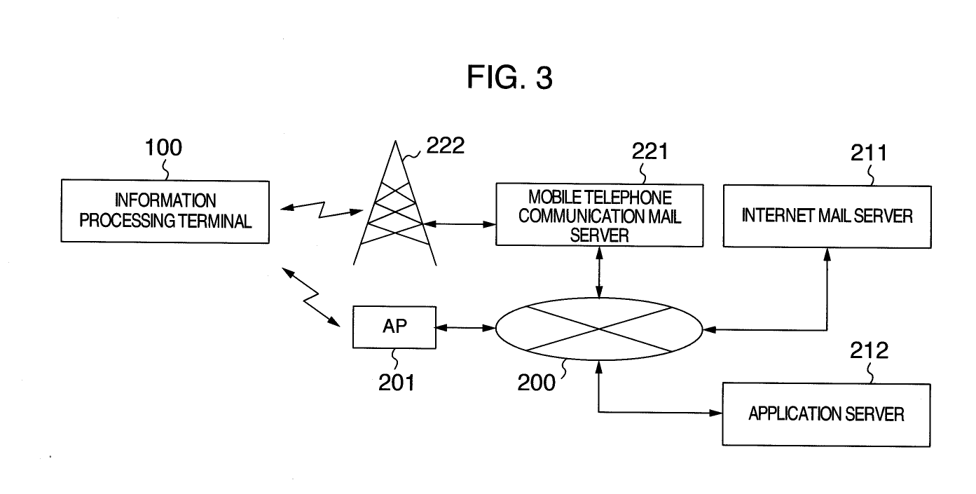

FIG. 3 shows an example of a communication system including the portable information processing terminal 100 in the present example. The communication system includes, for example, a public network 200 such as Internet, its wireless communication access point 201, an Internet mail server 211, an application server 212, a mobile telephone communication mail server 221, and a base station 222 in a mobile telephone communication network.

The portable information processing terminal 100 may be a portable telephone or a smart phone. Or the portable information processing terminal 100 may be a PDA (Personal Digital Assistant), a handy type PC (Personal Computer), or a tablet PC. The portable information processing terminal 100 may be a portable game machine, a digital camera, or another portable digital device. In addition, the technique according to the present invention can be applied not only to portable digital devices, but also to, for example, stationary PCs and control of money withdrawal function lock in ATMs of banks or the like, and door open/close function control in a room entrance and leaving management apparatus.

The control unit 101 is, for example, a microprocessor which controls the whole system of the portable information terminal 100. The system bus 102 is a data communication path for conducting data transmission and reception between the control unit 101 and respective units in the portable information terminal 100. The ROM (Read Only Memory) 103 is a memory which stores basic operation programs, such as an operating system and predetermined application programs of the portable information terminal 100. A rewritable ROM, such as, for example, an EEPROM (Electrically Erasable Programmable ROM) or a flash ROM, is used as the ROM 103. It is supposed that version up and function expansion of the basic operation programs can be conducted by updating the programs stored in the ROM 103. By the way, the ROM 103 may not have an independent configuration unlike FIG. 1, but a part of a storage area in the storage unit 110 may be used. The RAM (Random Access Memory) 104 becomes a work area when executing a basic operation program or each application. Furthermore, the ROM 103 and the RAM 104 may be integral with the control unit 101.

The storage unit 110 stores respective operation set values of the portable information terminal 100 and individual information (such as an address book or a schedule) of a user of the portable information terminal 100. The storage unit 110 has a facial recognition information storage area 111 and a rest information storage area 112 therein. Details of the facial recognition information storage area 111 will be described later. Furthermore, a partial area of the rest information storage area 112 may be substituted for the whole or a part of the function of the ROM 103.

It is supposed that the portable information terminal 100 can expand its function by downloading a new application from the application server 212 via the telephone network communication unit 161 or the LAN communication unit 162. At this time, the downloaded application is stored in the rest information storage area 112 in the storage unit 110. It is supposed that the portable information terminal 100 can implement various functions by evolving the application stored in the rest information storage area 112 in the storage unit 110 onto the RAM 104 at the time of use and executing it.

The storage unit 110 needs to retain stored information even if the portable information terminal 100 is in a power off state. Therefore, for example, a flash ROM, an SSD (Solid State Drive), an HDD (Hard Disc Drive), or the like is used.

The acceleration sensor 121, the gyro sensor 122, the terrestrial magnetism sensor 123, the GPS receiving unit 124, and the like detect states of the portable information terminal 100. It becomes possible to detect the motion, inclination, position, direction and the like of the portable information terminal 100 owing to these sensors. The illuminance sensor 125 detects brightness around the portable information terminal 100.

The external interface 130 is an interface for expanding the function of the portable information terminal 100. Connection of a USB (Universal Serial Bus) device or a memory card, or connection of a video cable to display a video on an external monitor is conducted.

The display unit 141 is a display device, such as, for example, a liquid crystal panel. The display unit 141 provides a user of the portable information terminal 100 with a video signal processed in the display processing unit 142. The video input unit 143 is a camera, which converts light incident from a lens to an electric signal and thereby inputs image data of the periphery or an object substance. The speaker 144 provides the user of the portable information terminal 100 with an audio signal processed in the audio processing unit 145. The audio input unit 146 is a microphone, which inputs audio data such as a voice of the user.

The operation unit 150 is a command input unit which inputs a command on the basis of an operation conducted by the user of the portable information terminal 100. The operation unit 150 conducts character inputting and conducts operation on an application under execution. The operation unit 150 may be implemented by using multiple keys formed by arranging button switches or may be implemented by using a touch panel disposed to be superposed on the display unit 141. Or both of them may be used jointly. In the present embodiment, it is supposed that the operation unit 150 is composed of a plurality of button switches (not illustrated) and a touch panel disposed to be superposed on the display unit 141.

The telephone network communication unit 161 conducts communication with the base station 222 in the mobile telephone communication network. The LAN (Local Area Network) communication unit 162 conducts communication with the wireless communication access point 201 in the Internet 200 by using the Wi-Fi (registered trademark) or the like. Each of the telephone network communication unit 161 and the LAN communication unit 162 includes an antenna, a coding circuit, and a decoding circuit.

The mail processing unit 170 is composed of a microprocessor or the like to conduct mail making and mail analysis. In FIG. 1, the mail processing unit 170 is illustrated as an independent configuration. Instead, the control unit 101 may implement the same function by using the RAM 104 as a work area and executing a predetermined program.

The terminal lock control unit 181 is composed of a microprocessor or the like. The terminal lock control unit 181 controls restrictions (hereafter referred to as “terminal lock” in some cases) on a part or the whole of functions or operations of the portable information terminal 100. The concordance rate confirmation unit 182 is provided to compare a facial recognition image of the recognition registrant stored in the facial recognition information storage area 111 in the storage unit 110 with a facial image of a recognition object person taken in by the video input unit 143 and confirm its concordance rate. Details of the terminal lock control unit 181 and the concordance rate confirmation unit 182 will be described later. The restriction control on predetermined functions in the terminal lock control unit 181 and the concordance rate confirmation processing in the concordance rate confirmation unit 182 may also be implemented by the control unit 101 instead.

By the way, a large number of configurations which are not indispensable to the present embodiment not to speak of the sensors 121 to 125 are included in the configuration example of the portable information terminal 100 shown in FIG. 1. Furthermore, as for the telephone network communication unit 161 and the LAN communication unit 162, it is desirable that at least one of them is provided. Even in a configuration having neither of them, however, the effects of the present embodiment are not hampered. Furthermore, configurations which are not illustrated, such as a digital television broadcast receiving function and an electronic money settling function, may be added.

It is supposed that the portable information terminal 100 in the present embodiment has the terminal lock function to restrict predetermined functions and setting and cancel of the terminal lock function is conducted on the basis of the facial recognition image stored in the facial recognition information storage area 111 in the storage unit 110. It is supposed that in the terminal lock state the portable information terminal 100 basically does not accept operations other than an operation for unlocking the terminal.

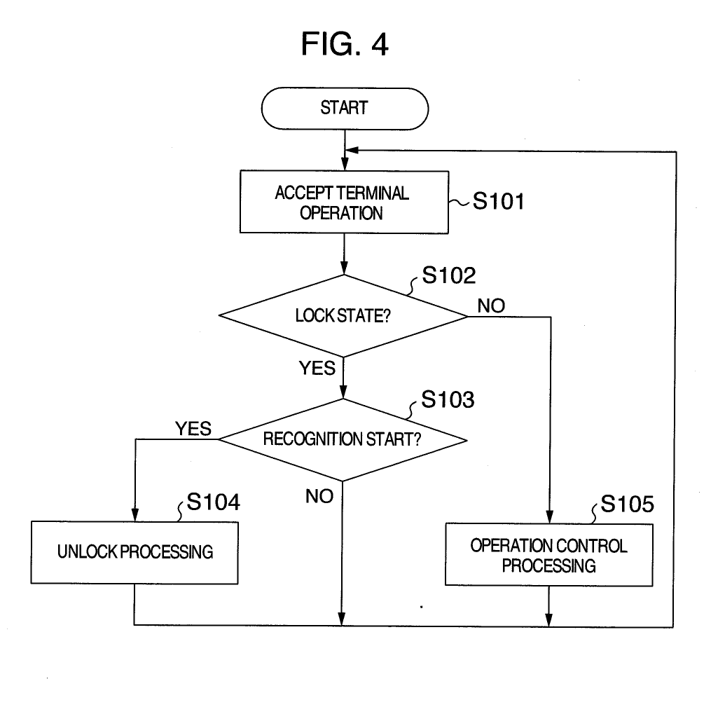

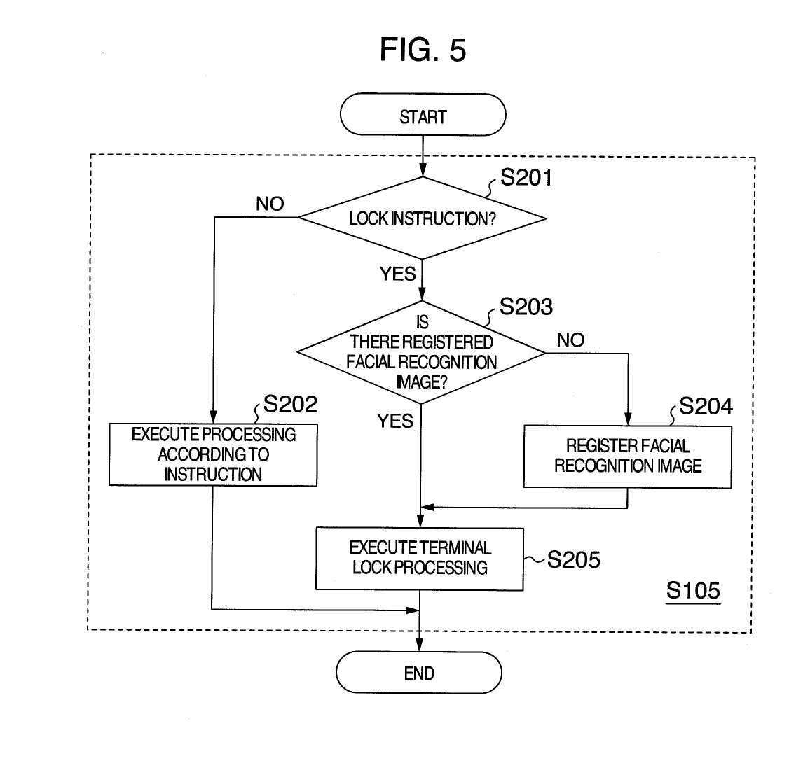

The portable information terminal 100 in the present embodiment conducts operations described hereafter at the time of ordinary processing according to terminal operations of a user. The operations will be described with reference to flow charts shown in FIGS. 4 and 5.

When the power supply is on, the portable information terminal 100 is typically in a function waiting state. If a terminal operation for the operation unit 150 or the like conducted by the user is accepted during the function waiting (S101), the portable information terminal 100 first ascertains whether its own machine is in the terminal lock state (S 102). If it is ascertained at S102 that the portable information terminal 100 is in the terminal lock state, then a decision is made whether the terminal operation at S101 is recognition start processing for unlocking the terminal (S103). If it is judged at S103 that the terminal operation at S101 is not the recognition start processing for unlocking the terminal, the portable information terminal 100 disregards the terminal operation and returns to the function waiting state. On the other hand, if the terminal operation at S101 is judged to be recognition start processing for unlocking the terminal, the portable information terminal 100 conducts terminal unlock processing (S 104) and then returns to the function waiting state. The terminal unlock processing will be described later. If it is ascertained at S102 that the portable information terminal 100 is not in the terminal lock state, the portable information terminal 100 conducts operation control processing according to the terminal operation conducted at S101 (S105).

FIG. 5 shows an example of detailed processing of the operation control processing conducted at S105. First, a decision is made whether the terminal operation conducted at S101 is an instruction for executing terminal lock (S201). If the terminal operation conducted at S101 is judged at S201 not to be an instruction for executing terminal lock, the portable information terminal 100 executes other processing according to the terminal operation (S202) and then returns to the function waiting state. On the other hand, if the terminal operation conducted at S101 is judged at S201 to be an instruction for executing terminal lock, the portable information terminal 100 first ascertains whether there is a facial recognition image of a recognition registrant stored (registered) in the facial recognition information storage area 111 in the storage unit 110 (S203). If it is judged at S203 that there is a facial recognition image of a recognition registrant stored (registered) in the facial recognition information storage area 111, the portable information terminal 100 immediately executes terminal lock processing for restricting predetermined functions of the portable information terminal 100 on the basis of the facial recognition image of the recognition registrant stored in the facial recognition information storage area 111 under control of the terminal lock control unit 181 (S205). If it is judged at S203 that there isn't a facial recognition image of a recognition registrant stored in the facial recognition information storage area 111, the portable information terminal 100 executes registration processing of a facial recognition image of the recognition registrant (S204) and then executes terminal lock processing for restricting predetermined functions of the portable information terminal 100 on the basis of the facial recognition image of the recognition registrant stored in the facial recognition information storage area 111 under control of the terminal lock control unit 181 (S205).

Hereafter, an example concerning the control of the terminal unlock processing at S104 and display of a facial image of a recognition object person and the recognition concordance rate at the time of the terminal unlock processing, which is a feature of the present embodiment, will be described in detail.

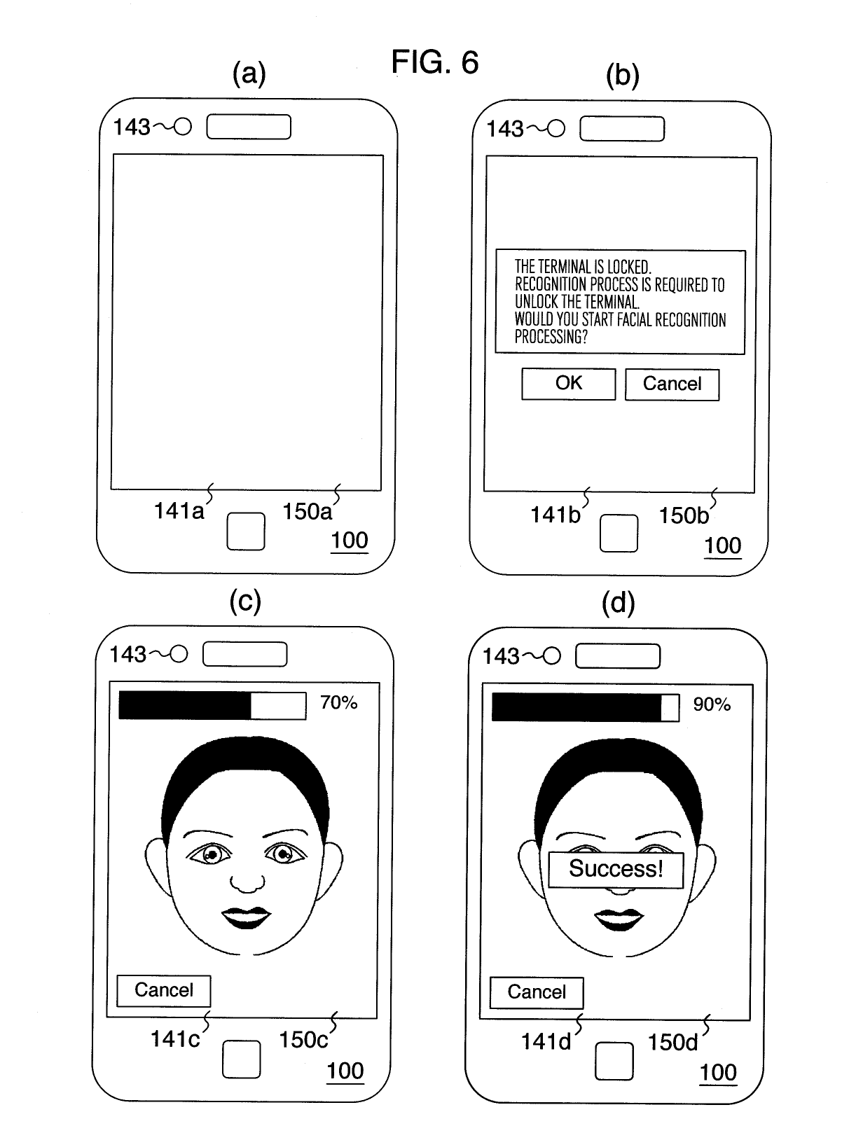

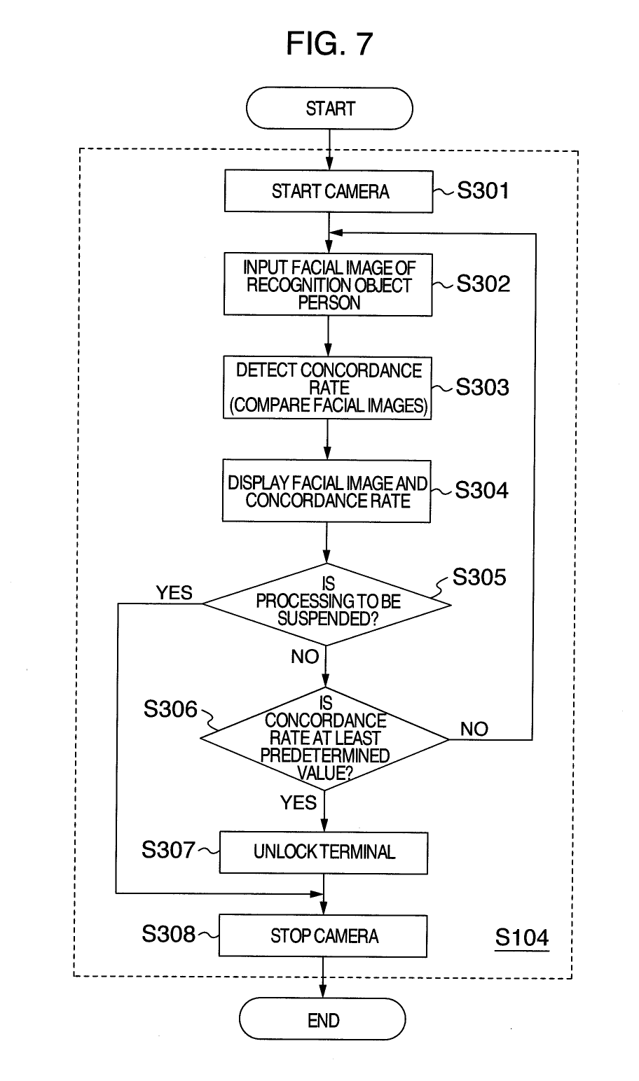

An example of control of the terminal unlock processing in the portable information terminal 100 will now be described with reference to screen display views shown in FIG. 6 and a flow chart shown in FIG. 7.

It is supposed that in the portable information terminal 100 in the terminal lock state, nothing is displayed or an image such as a screen saver is displayed on a display unit 141a in the function waiting state as shown in (a) of FIG. 6. If in this state a terminal operation for the operation unit 150 is accepted (a touch operation on a touch panel 150a is conducted in the present embodiment), the portable information terminal 100 displays a message to the effect that the portable information terminal 100 is in the terminal lock state and a message to the effect that facial recognition processing is needed to unlock the terminal on a display unit 141b as shown in (b) of FIG. 6.

If a “Cancel” part in a touch panel 150b is touched, the series of operations is judged not to be recognition start processing for unlocking the terminal and a return to the function waiting state is conducted. On the other hand, if an “OK” part in the touch panel 150b is touched, the series of operations is judged to be recognition start processing for unlocking the terminal and the terminal unlock processing at S104 is started.

In the terminal unlock processing at S104, first, a camera function of the video input unit 143 is made effective to conduct facial recognition processing (S301). Then, the video input unit 143 starts inputting of a facial image of a recognition object person by using its camera function (S302). At the same time, the concordance rate confirmation unit 182 detects a concordance rate by comparing and collating the facial recognition image of the recognition object person which is input with the facial recognition image of the recognition registrant stored in the facial recognition information storage area 111 in the storage unit 110 (S303). By the way, the detection of the concordance rate using the comparative collation on the facial recognition image can be conducted by, for example, comparing respective relative distances among feature points extracted from eyes, nose, corners of the mouth, a face contour and the like and determining a ratio of the number of concordances to the total number to be the concordance rate.

In addition, the facial image of the recognition object person which is input by the camera function of the video input unit 143 and the concordance rate detected by the concordance rate confirmation unit 182, which is the result of the comparative collation between the facial image of the recognition object person and the facial recognition image of the recognition registrant, are displayed in a display unit 141c at the same time (S304). By the way, in the present embodiment, the concordance rate is displayed by a graphic and a numerical value in the vicinity of an upper side of the display unit 141c as shown in (c) of FIG. 6. As for the display of the concordance rate using a graphic, the concordance rate is represented by, for example, painting out the inside of a rectangle which is long sideways from the left side of the screen toward the right side at the same rate as the concordance rate. In addition, the concordance rate is displayed by a numerical value to the right side of the concordance rate displayed by the graphic side by side. By the way, instead of displaying the concordance rate between the facial image of the recognition object person and the facial recognition image of the recognition registrant on the display unit 141 as it is, the control unit 101 may conduct predetermined processing on the concordance rate detected by the concordance rate confirmation unit 182, such as rounding the concordance rate to the nearest multiple of ten or discarding a part of the concordance rate less than ten to obtain a multiple of ten, and information obtained as a result may be displayed on the display unit 141.

If a “Cancel” part in a touch panel 150c is touched, then the terminal unlock processing is suspended (S305), the camera function of the video input unit 143 is stopped (S308), and a return to the function waiting state is conducted. In this case, the terminal lock state of the portable information terminal 100 is continued.

Unless the “Cancel” part in the touch panel 150c is touched, a decision is made whether the concordance rate detected by the concordance rate confirmation unit 182, which is the result of the comparative collation between the facial image of the recognition object person and the facial recognition image of the recognition registrant, is at least a predetermined value (i.e., a threshold for permitting unlock of the terminal, which is 80% in the present embodiment) (S306).

If the concordance rate is less than the predetermined value at S306, a facial image of the recognition object person is newly input by using the camera function of the video input unit again (S302) and then the processing at S303 to S306 is repeated. On the other hand, if the concordance rate is at least the predetermined value at S306, “Success” is displayed on a display unit 141d for a determinate time and in addition terminal unlock processing is executed as shown in (d) of FIG. 6 (S307). In addition, the camera function of the video input unit 143 is stopped (S308) and a return to the function waiting state is conducted.

As for the portable information terminal 100 in the present embodiment, in the facial recognition processing in the process of the terminal unlock processing, the facial image of the recognition object person which is input by using the camera function of the video input unit 143 and the concordance rate detected by the concordance rate confirmation unit 182, which is the result of comparative collation between the facial image of the recognition object person and the facial recognition image of the recognition registrant, can be confirmed immediately and concurrently, as described heretofore.

In particular, if the concordance rate detected by the concordance rate confirmation unit 182, which is the result of comparative collation between the facial image of the recognition object person and the facial recognition image of the recognition registrant, is less than the predetermined value required to unlock the portable information terminal 100, then the processing at S302 to S306 is executed consecutively and repeatedly as long as a touch operation is conducted on the “Cancel” part displayed in the display unit 141c in the processing at S305. In other words, if the camera function of the video input unit 143 is capable of inputting moving pictures of, for example, 60 frames per second, the processing at S302 to S306 is also repeated 60 times per second consecutively. As a result, the facial image of the recognition object person and the concordance rate displayed in the display unit 141c are also updated and displayed at the rate of 60 times per second.

When a recognition object person who is the recognition registrant himself or herself inputs a face of himself or herself by using the camera function of the video input unit 143 to conduct facial recognition processing, the concordance rate required to unlock the portable information terminal 100 is not obtained in some cases under the influence of a relative angle between the face of the recognition object person and the video input unit 143 in the portable information terminal 100, difference in expression of the face of the recognition object person, and the like. Even in such a case, it becomes possible, owing to the consecutive update and display, to make adjustments to provide the concordance rate with a magnitude required to unlock the portable information terminal 100 by changing the relative angle between the face of the recognition object person and the video input unit 143 in the portable information terminal 100 or changing the expression of the face of the recognition object person while confirming the facial image of the recognition object person and the magnitude of the concordance rate which are displayed in the display unit 141c and updated consecutively.

In the facial recognition, recognition omission in which recognition fails although the recognition object person is the recognition registrant occurs in some cases. Because when picking up a facial image of the recognition object person by using the camera function of the video input unit 143 in the information processing terminal 100 at the time of recognition processing, a necessary concordance rate might not be obtained in the comparative collation with the facial image of the recognition registrant stored in the facial recognition information storage area 111 in the storage unit 110 under the influence of brightness around the recognition object person, direction of the face of the recognition object person with respect to the video input unit 143, a slight change of the expression, or the like. For reducing the recognition omissions, the threshold of the concordance rate required for recognition should be set to be low. In this case, however, false recognition in which a recognition object person who is different from the recognition registrant is conversely recognized poses a problem. Considering the aspect of security, false recognition is a more serious problem than recognition omission. Therefore, a facial recognition technique in which the threshold of the concordance rate required for recognition is set to be high and convenience is not hampered is desired.

In the portable information terminal 100 in the present embodiment, it is possible for the recognition object person to make adjustments to provide the concordance rate with a magnitude required to unlock the portable information terminal 100 by making it possible to change the relative angle between the face of the recognition object person and the video input unit 143 in the portable information terminal 100 or change the expression of the face of the recognition object person while confirming the facial image of the recognition object person and the magnitude of the concordance rate which are updated and displayed consecutively in the display unit 141c as described above. In addition, in the portable information terminal 100, at least one kind of facial recognition image of the recognition registrant need only be stored in the facial recognition information storage area 111 in the storage unit 110. As a result, the storage capacity of the facial recognition information storage area 111 can be minimized and registration processing of the facial recognition information can also be simplified. In other words, it becomes possible to implement a useful, more convenient facial recognition function which does not require a storage area of large capacity to store the recognition information and which is capable of conducting efficient recognition processing with simple registration processing.

By the way, in the above-described example, the camera function of the video input unit 143 is capable of inputting images of 60 frames per second as a moving picture. In addition, an example in the case where the detection processing of the concordance rate in the concordance rate confirmation unit 182 is also conducted at a rate of 60 times per second has been described. However, the detection processing of the concordance rate in the concordance rate confirmation unit 182 may be conducted, for example, at a rate of 30 times per second or at a rate of 15 times per second. If the number of times of the detection processing of the concordance rate in the concordance rate confirmation unit 182 is reduced, a device which is low in processing capability and inexpensive can be used as hardware which constitutes the concordance rate confirmation unit 182. At the same time, it becomes possible to reduce the power dissipation at the time of concordance rate detection processing in the concordance rate confirmation unit 182.

The number of times of the detection processing of the concordance rate in the concordance rate confirmation unit 182 may be set equal to an arbitrary number of times. If the number of frames of an image which can be input by the camera function of the video input unit 143 is m frames per second and the number of times of the concordance rate detection processing is n times per second, however, it is desirable to conduct setting to satisfy a relation “n is a positive measure of m.” By such setting, hardware configuration or software configuration of the concordance rate confirmation unit 182 can be simplified.

As a matter of course, the number of frames of an image which can be input by the camera function of the video input unit 143 is not restricted to the above-described 60 times per second, but may be 120 times per second, 50 times per second, or the like.

The facial image of the recognition object person which is input by the camera function of the video input unit 143 as a moving picture partially protrude from a predetermined area in some cases. Processing of temporarily suspending the concordance rate detection processing in the concordance rate confirmation unit 182 in such a case even in the midst of the facial recognition processing may be added. By doing so, useless processing can be omitted and as a result it becomes possible to implement reduction of the power dissipation.

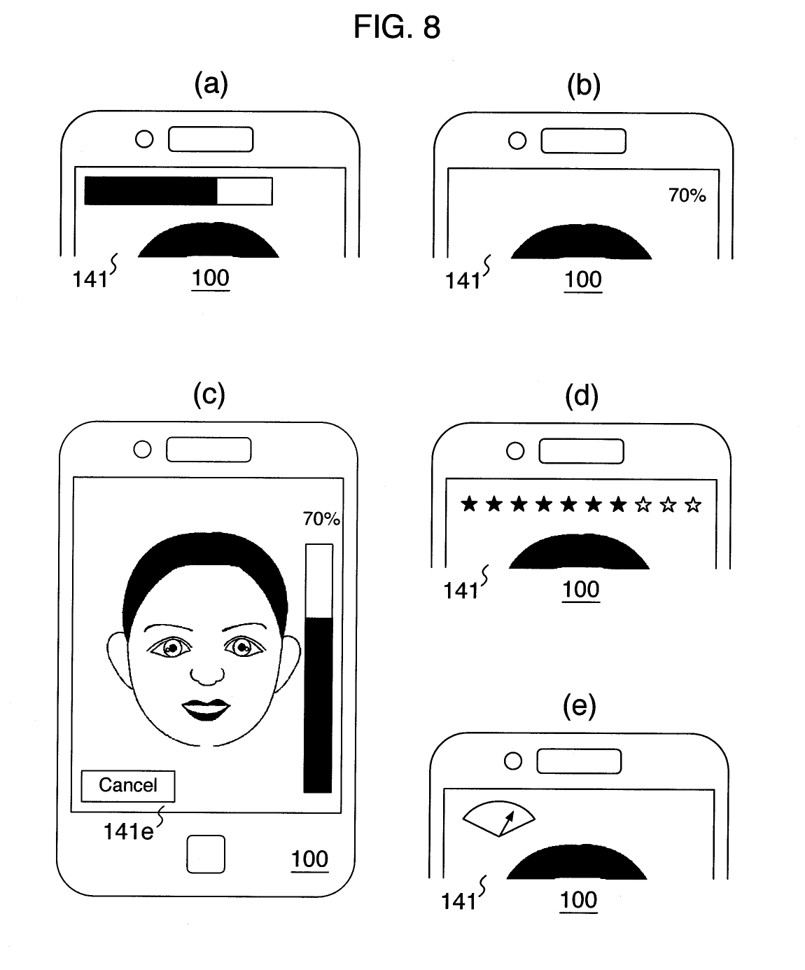

In the above-described embodiment, the concordance rate detected by the concordance rate confirmation unit 182, which is the result of comparative collation between the facial image of the recognition object person and the facial recognition image of the recognition registrant, is displayed in the vicinities of the upper sides of the display units 141c and 141d with both a graphic and a numerical value as shown in (c) and (d) of FIG. 6. However, this is nothing but an example. For example, as shown in FIG. 8, the concordance rate may be displayed only with a graphic ((a) of FIG. 8) or may be displayed only with a numerical value ((b) of FIG. 8). Furthermore, the display position may be in the vicinity of the right side of a display unit 141e ((c) of FIG. 8). When displaying the concordance rate only with a graphic, the concordance rate may be displayed by the number of star marks ((d) of FIG. 8) instead of painting out the inside of a rectangle which is long sideways from the left side of the screen toward the right side at the same rate as the concordance rate as in the above-described embodiment. Instead of the star marks, character images such as dogs, cats, automobiles, or airplanes may be used. The concordance rate may be displayed by a meter-shaped graphic ((e) of FIG. 8).

### Embodiment 2

An embodiment 2 will now be described. When displaying the facial image of the recognition object person which is input by the camera function of the video input unit 143 and the concordance rate detected by the concordance rate confirmation unit 182, which is the result of the comparative collation between the facial image of the recognition object person and the facial recognition image of the recognition registrant, in the display unit 141 at the same time, display is conducted in the embodiment 2 to facilitate visual judgment as to whether the concordance rate is at least the predetermined value (hereafter referred to as first predetermined value), i.e., whether the concordance rate is a magnitude required to unlock the portable information terminal 100.

For example, in the portable information terminal 100 in the present embodiment, control is exercised to change the display color of the numerical value or graphic representing the concordance rate depending upon whether the concordance rate detected by the concordance rate confirmation unit 182 is at least the first predetermined value or is less than the first predetermined value. Furthermore, if the concordance rate detected by the confirmation unit 182 is less than the first predetermined value, control is exercised to further change the display color of the numerical value or graphic representing the concordance rate depending upon whether the concordance rate is at least a second predetermined value or is less than the second predetermined value.

By the way, in the present embodiment, for example, the first predetermined value is set equal to 80% and the second predetermined value is set equal to 60%. The second predetermined value is a numerical value which becomes a criterion as to whether there is a possibility that the concordance rate will be able to have a magnitude required to unlock the portable information terminal 100 by making adjustments, such as changing the relative angle between the face of the recognition object person and the video input unit 143 in the portable information terminal 100 or changing the expression of the face of the recognition object person, in the comparative collation between the facial image of the recognition object person and the facial recognition image of the recognition registrant. In other words, if the concordance rate detected by the concordance rate confirmation unit 182 is at least the second predetermined value (60%) although it is less than the first determined value (80%), then there is a possibility that the concordance rate will be able to have a magnitude required to unlock the portable information terminal 100 by making adjustments, such as changing the relative angle between the face of the recognition object person and the video input unit 143 in the portable information terminal 100 or changing the expression of the face of the recognition object person. Therefore, the case where the concordance rate is at least the second predetermined value (60%) is made distinguishable easily from the case where the concordance rate is less than the second predetermined value (60%).

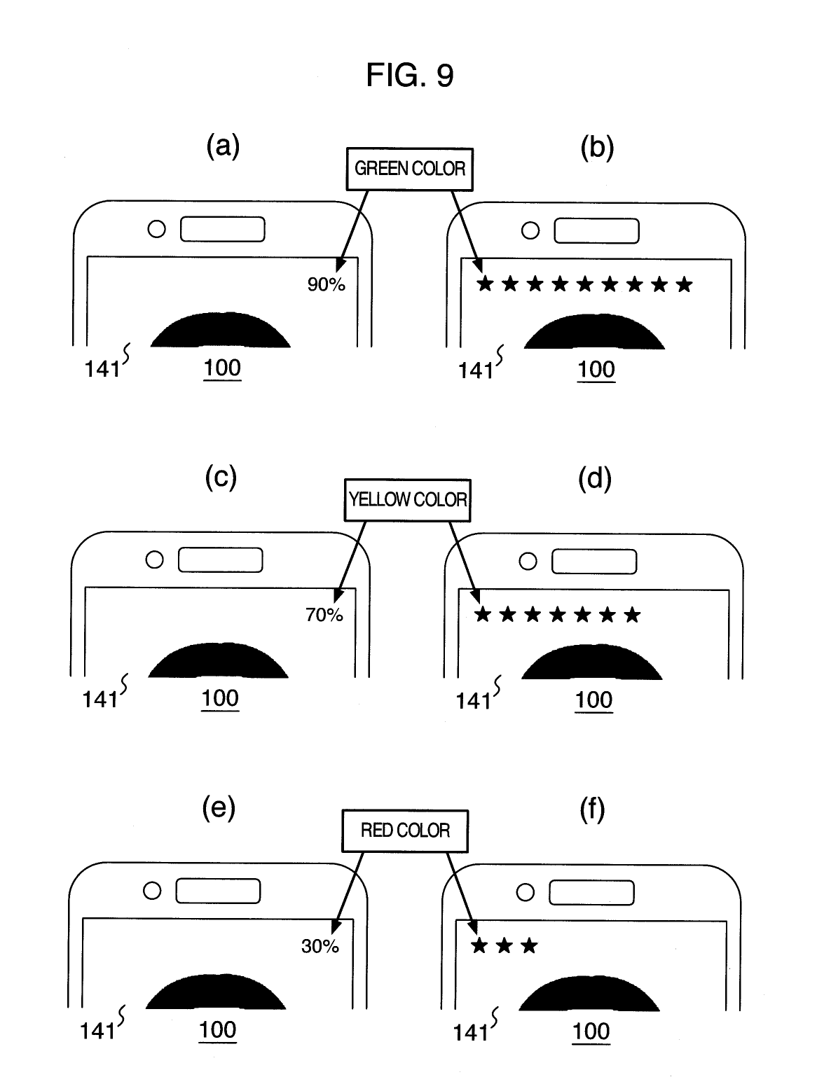

For example, control is exercised as shown in FIG. 9. If the concordance rate detected by the concordance rate confirmation unit 182 is 90% (at least the first predetermined value), the display color of the numerical value or graphic is made green ((a) and (b) of FIG. 9). If the concordance rate detected by the concordance rate confirmation unit 182 is 70% (less than the first predetermined value and at least the second predetermined value), the display color of the numerical value or graphic is made yellow ((c) and (d) of FIG. 9). If the concordance rate detected by the concordance rate confirmation unit 182 is 30% (less than the second predetermined value), the display color of the numerical value or graphic is made red ((e) and (f) of FIG. 9).

When confirming the facial image of the recognition object person which is input by the camera function of the video input unit 143 and displayed in the display unit 141, and the concordance rate detected by the concordance rate conformation unit 182, which is the result of the comparative collation between the facial image of the recognition object person and the facial recognition image of the recognition registrant, it becomes possible, owing to the processing described heretofore, to ascertain easily whether the concordance rate has a magnitude required to unlock the portable information terminal 100 or whether it is possible for the concordance rate to have a magnitude required to unlock the portable information terminal 100. As a result, it becomes possible to provide a portable information terminal having a more useful facial recognition function.

### Embodiment 3

An embodiment 3 will now be described. When displaying the facial image of the recognition object person which is input by the camera function of the video input unit 143 and the concordance rate detected by the concordance rate confirmation unit 182, which is the result of the comparative collation between the facial image of the recognition object person and the facial recognition image of the recognition registrant, in the display unit 141 at the same time, display is conducted in the embodiment 3 to facilitate visual judgment as to the magnitude of the concordance rate in a way different from that of the embodiment 2.

For example, in the portable information terminal 100 in the present embodiment, control is exercised to change the size of the numerical value or graphic representing the concordance rate depending upon whether the concordance rate detected by the concordance rate confirmation unit 182 is at least the first predetermined value or is less than the first predetermined value. Furthermore, if the concordance rate detected by the confirmation unit 182 is less than the first predetermined value, control is exercised to further change the size of the numerical value or graphic representing the concordance rate depending upon whether the concordance rate is at least a second predetermined value or is less than the second predetermined value.

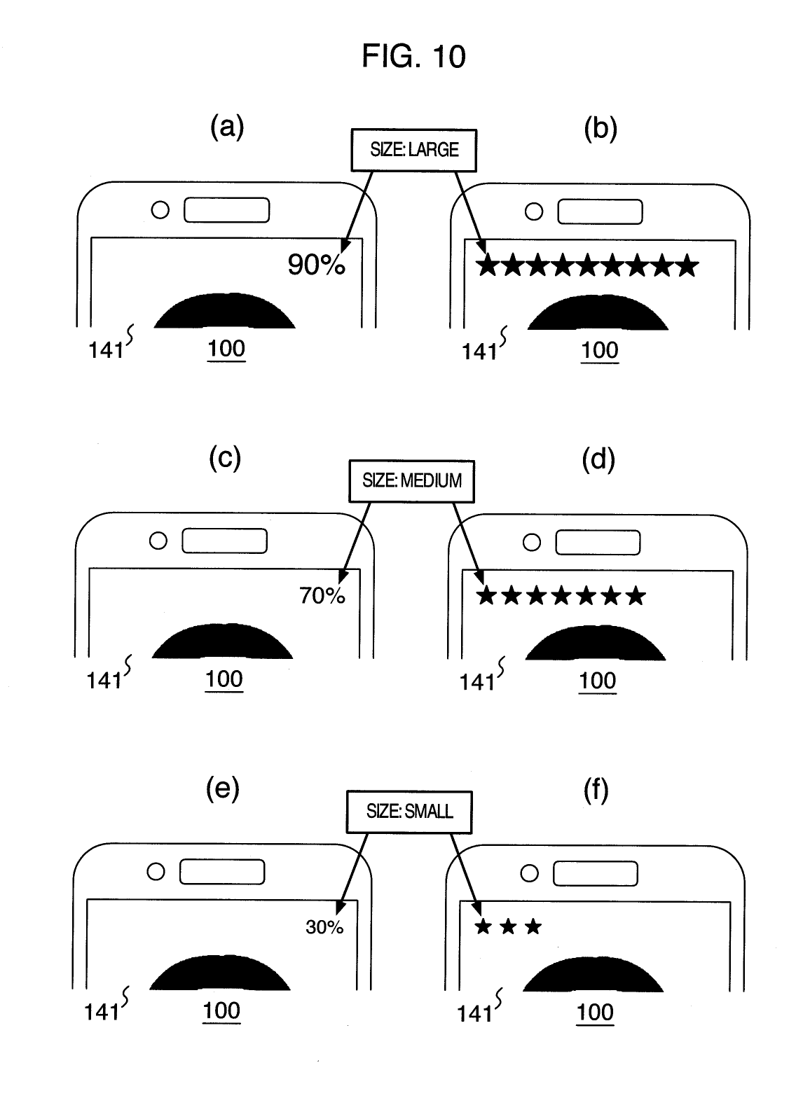

For example, control is exercised as shown in FIG. 10. If the concordance rate detected by the concordance rate confirmation unit 182 is 90% (at least the first predetermined value), the display size of the numerical value or graphic is made large ((a) and (b) of FIG. 10). If the concordance rate detected by the concordance rate confirmation unit 182 is 70% (less than the first predetermined value and at least the second predetermined value), the display size of the numerical value or graphic is made medium ((c) and (d) of FIG. 10). If the concordance rate detected by the concordance rate confirmation unit 182 is 30% (less than the second predetermined value), the display size of the numerical value or graphic is made small ((e) and (f) of FIG. 10).

When confirming the facial image of the recognition object person which is input by the camera function of the video input unit 143 and displayed in the display unit 141, and the concordance rate detected by the concordance rate conformation unit 182, which is the result of the comparative collation between the facial image of the recognition object person and the facial recognition image of the recognition registrant, it becomes possible, owing to the processing described heretofore, to ascertain easily whether the concordance rate has a magnitude required to unlock the portable information terminal 100 or whether it is possible for the concordance rate to have a magnitude required to unlock the portable information terminal 100, in the same way as the case of embodiment 2. As a result, it becomes possible to provide a portable information terminal having a more useful facial recognition function.

### Embodiment 4

An embodiment 4 will now be described. When displaying the facial image of the recognition object person which is input by the camera function of the video input unit 143 and the concordance rate detected by the concordance rate confirmation unit 182, which is the result of the comparative collation between the facial image of the recognition object person and the facial recognition image of the recognition registrant, in the display unit 141 at the same time, display is conducted in the embodiment 4 to facilitate visual judgment as to the magnitude of the concordance rate in a way different from that of the embodiment 2 and that of the embodiment 3.

For example, in the portable information terminal 100 in the present embodiment, control is exercised to change the way of flashing of the numerical value or graphic representing the concordance rate depending upon whether the concordance rate detected by the concordance rate confirmation unit 182 is at least the first predetermined value or is less than the first predetermined value. Furthermore, if the concordance rate detected by the confirmation unit 182 is less than the first predetermined value, control is exercised to further change the way of flashing of the numerical value or graphic representing the concordance rate depending upon whether the concordance rate is at least a second predetermined value or is less than the second predetermined value.

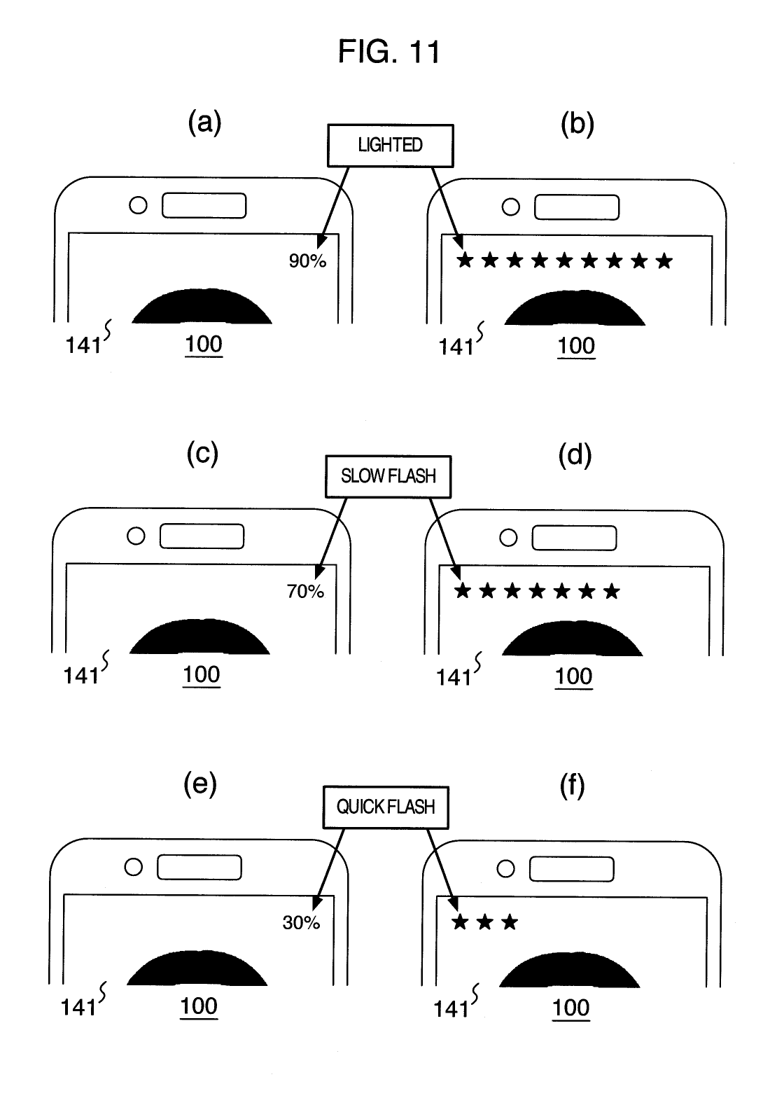

For example, control is exercised as shown in FIG. 11. If the concordance rate detected by the concordance rate confirmation unit 182 is 90% (at least the first predetermined value), the numerical value or graphic is always displayed (not flashing but lighted) ((a) and (b) of FIG. 11). If the concordance rate detected by the concordance rate confirmation unit 182 is 70% (less than the first predetermined value and at least the second predetermined value), the numerical value or graphic is made to flash slowly ((c) and (d) of FIG. 11). If the concordance rate detected by the concordance rate confirmation unit 182 is 30% (less than the second predetermined value), the numerical value or graphic is made to flash quickly ((e) and (f) of FIG. 11).

When confirming the facial image of the recognition object person which is input by the camera function of the video input unit 143 and displayed in the display unit 141, and the concordance rate detected by the concordance rate conformation unit 182, which is the result of the comparative collation between the facial image of the recognition object person and the facial recognition image of the recognition registrant, it becomes possible, owing to the processing described heretofore, to ascertain easily whether the concordance rate has a magnitude required to unlock the portable information terminal 100 or whether it is possible for the concordance rate to have a magnitude required to unlock the portable information terminal 100, in the same way as the cases of the embodiment 2 and the embodiment 3. As a result, it becomes possible to provide a portable information terminal having a more useful facial recognition function.

### Embodiment 5

An embodiment 5 will now be described. When displaying the facial image of the recognition object person which is input by the camera function of the video input unit 143 and the concordance rate detected by the concordance rate confirmation unit 182, which is the result of the comparative collation between the facial image of the recognition object person and the facial recognition image of the recognition registrant, in the display unit 141 at the same time, display is conducted in the embodiment 5 to facilitate visual judgment as to the magnitude of the concordance rate in a way different from that of the embodiment 2, that of the embodiment 3, and that of the embodiment 4.

For example, in the portable information terminal 100 in the present embodiment, control is exercised to change the display position of a graphic representing the concordance rate depending upon the magnitude of the concordance rate detected by the concordance rate confirmation unit 182.

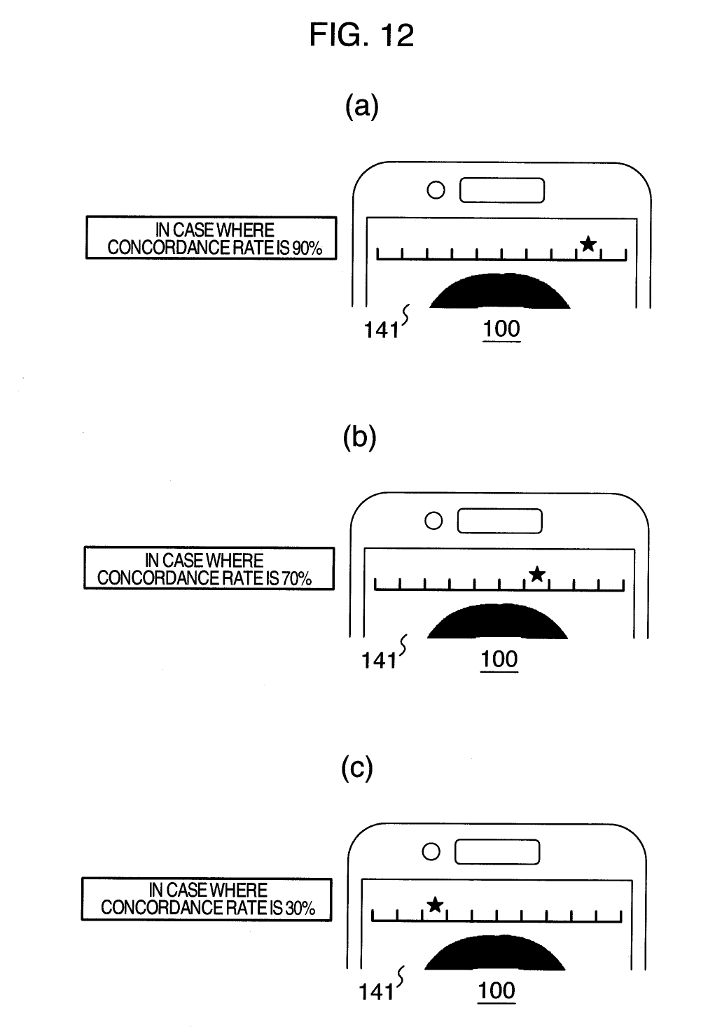

For example, control is exercised as shown in FIG. 12. If the concordance rate detected by the concordance rate confirmation unit 182 is 90% (at least the first predetermined value), the graphic is displayed in a position shown in (a) of FIG. 12. If the concordance rate detected by the concordance rate confirmation unit 182 is 70% (less than the first predetermined value and at least the second predetermined value), the graphic is displayed in a position shown in (b) of FIG. 12. If the concordance rate detected by the concordance rate confirmation unit 182 is 30% (less than the second predetermined value), the graphic is displayed in a position shown in (c) of FIG. 12. As shown in FIG. 12, the distance between the left end of the display unit 141 and the star mark represents the magnitude of the concordance rate.

When confirming the facial image of the recognition object person which is input by the camera function of the video input unit 143 and displayed in the display unit 141, and the concordance rate detected by the concordance rate conformation unit 182, which is the result of the comparative collation between the facial image of the recognition object person and the facial recognition image of the recognition registrant, it becomes possible, owing to the processing described heretofore, to ascertain easily whether the concordance rate has a magnitude required to unlock the portable information terminal 100 or whether it is possible for the concordance rate to have a magnitude required to unlock the portable information terminal 100, in the same way as the cases of the embodiment 2, the embodiment 3, and the embodiment 4. As a result, it becomes possible to provide a portable information terminal having a more useful facial recognition function.

### Embodiment 6

In the examples described in the first to fifth embodiments, the portable information terminal 100 has a terminal lock function and the control of canceling the terminal lock function is exercised by comparing and collating a facial image of a recognition object person which is input by the camera function of the video input unit 143 with a facial recognition image of a recognition registrant stored in the facial recognition information storage area 111 in the storage unit 110 and confirming a concordance rate, by use of facial recognition functions in respective embodiments.

However, a facial recognition function in the present embodiment is not restricted to the case where the control of the terminal lock function is aimed at as in the above-described embodiments, but the facial recognition function in the present embodiment can be applied to other purposes as well. For example, in a conceivable example, the facial recognition function in the present embodiment is used in a game in which facial similarities are compared and confirmed among an owner of the portable information terminal 100 and friends of the owner.

In this case, the facial image of the owner of the portable information terminal 100 previously registered in the facial recognition information storage area 111 in the storage unit 110 may be compared with facial images of friends to confirm similarities. Or facial images of arbitrary two friends among the friends may be picked up newly by the camera function of the video input unit 143 and compared with each other to confirm similarities.

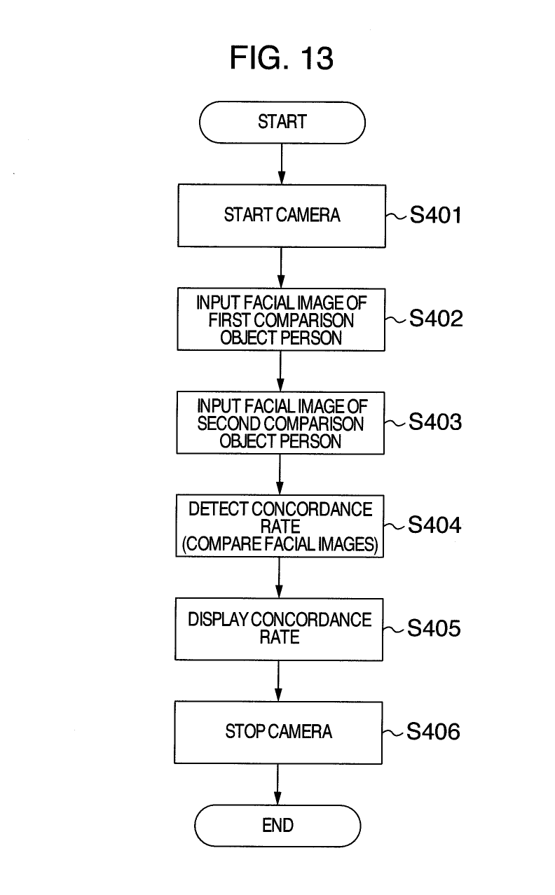

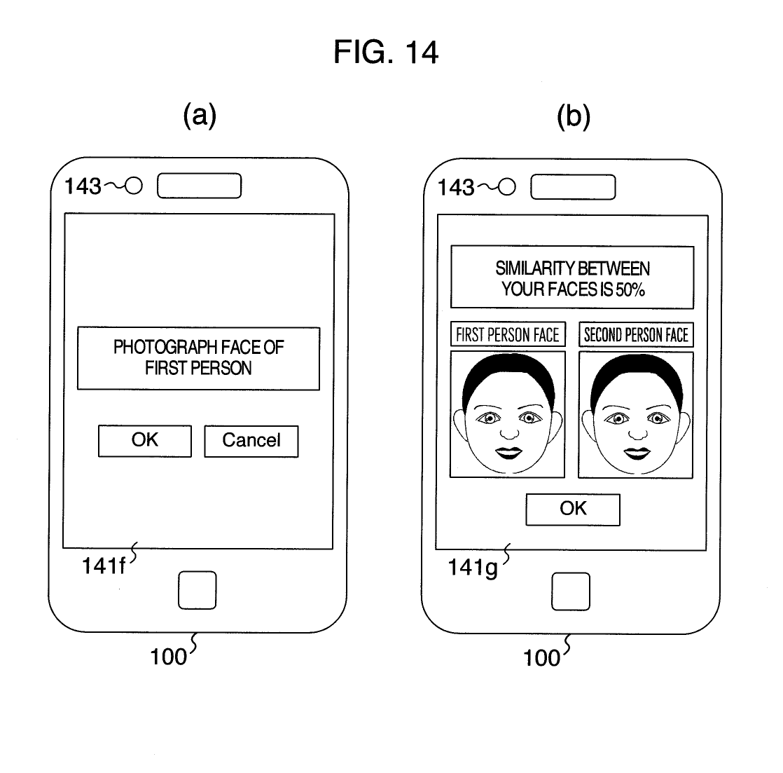

An example of processing at the time when newly picking up facial images of arbitrary two friends among the friends by the camera function of the video input unit 143 and comparing the facial images with each other to confirm similarities will be described with reference to a flow chart shown in FIG. 13 and screen display views shown in FIG. 14.

In the similarity confirmation processing, the camera function of the video input unit 143 is first made effective by starting an application for similarity confirmation (S401). Then, a message is displayed in a display unit 141f as shown in (a) of FIG. 14 to urge input of a facial image of a first comparison object person, and concurrently the facial image of the first comparison object person is input by using the camera function of the video input unit 143 (S402) and the facial image of the first comparison object person is stored in the facial recognition information storage area 111 in the storage unit 110. Then, a message is displayed in a display unit which is not illustrated to urge input of a facial image of a second comparison object person, and concurrently the facial image of the second comparison object person is input by using the camera function of the video input unit 143 (S403). In addition, the concordance rate confirmation unit 182 compares and collates the facial image of the first comparison object person and the facial image of the second comparison object person which are input, with each other and detects a concordance rate (S404). Finally, the facial image of the first comparison object person and the facial image of the second comparison object person which are input and a message representing a result of the comparative collation detected by the concordance rate confirmation unit 182 are displayed in a display unit 141g as shown in (b) of FIG. 14 (S405).

Owing to the processing described heretofore, it becomes possible to apply the facial recognition function in the present embodiment to an amusement in which a facial similarity between arbitrary two persons is confirmed. As a result, it becomes possible to enhance the value added of the portable information terminal mounting the present function.

Heretofore, examples of implementation of the present invention have been described with reference to the first to sixth embodiments. As a matter of course, however, the configuration for implementing the technique of the present invention is not restricted to the embodiments. For example, a configuration in a certain embodiment may be combined with a configuration of another embodiment. All of them belong to the category of the present invention. Furthermore, each of numerical values and message sentences appearing in the description and the drawings is nothing but an example. Even if a different numerical value or message sentence is used, the effects of the present invention are not hampered.

By the way, as for each of configurations, functions, and processing units, a part or all thereof may be implemented using hardware by, for example, designing integrated circuits. Furthermore, each of the configurations and functions may be implemented using software by causing a processor to interpret and execute a program which implements each function. Information such as a program, a table or a file which implements each function can be stored in a recording device such as a memory, a HDD, or a SSD, or on a recording medium such as an IC card or a SD card.

Furthermore, as for control lines and information lines, those considered to be necessary in description are shown. All control lines and information lines in a product are not necessarily shown. As a matter of fact, it may be considered that almost all configurations are connected mutually.

It should be further understood by those skilled in the art that although the foregoing description has been made on embodiments of the invention, the invention is not limited thereto and various changes and modifications may be made without departing from the spirit of the invention and the scope of the appended claims.

1. An information processing terminal capable of imposing restrictions on a predetermined function, the information processing terminal comprising:
an image input means capable of inputting a facial image of a recognition object person;
a facial image storage means for storing a facial image of a recognition registrant;
a concordance rate detection means for detecting a concordance rate between the facial image of the recognition object person which is input by the image input means and the facial image of the recognition registrant stored in the facial image storage means;
a restriction cancel means for canceling the restrictions on the predetermined function on the basis of the concordance rate detected by the concordance rate detection means;
a display means capable of displaying information; and
a display control means for exercising display control on the display means,
the display control means exercises control to display information concerning the concordance rate detected by the concordance rate detection means on the display means concurrently with the facial image of the recognition object person which is input by the image input means.

2. The information processing terminal according to claim 1, wherein
the image input means is an image input means capable of inputting a facial image of m frames per second,
the concordance rate detection means is a concordance rate detection means for comparing a facial image of the recognition object person of n frames out of the facial image of the recognition object person of m frames per second which is input by the image input means with the facial image of the recognition registrant stored in the facial image storage means and detecting a concordance rate, and
the n is a positive measure of the m.

3. The information processing terminal according to claim 1, wherein the display control means represents a magnitude of the concordance rate detected by the concordance rate detection means with a numerical value and/or a graphic.

4. The information processing terminal according to claim 3, wherein the display control means represents the magnitude detected by the concordance rate detection means with a numerical value or a graphic, and in case where the magnitude of the concordance rate is at least a predetermined value, display is conducted to provide a visual difference as compared with a case where the magnitude of the concordance rate is less than the predetermined value.

5. The information processing terminal according to claim 4, wherein the visual difference is obtained by changing at least one of a display color, a size, an interval of flashing, and a display position of the numerical value and/or the graphic representing the magnitude of the concordance rate.

6. A recognition control method for information processing terminal, the recognition control method comprising:
a function restriction process for imposing restrictions on a predetermined function;
an image input process for inputting a facial image of a recognition object person;
a facial image storage process for storing a facial image of a recognition registrant;
a concordance rate detection process for detecting a concordance rate between the facial image of the recognition object person which is input by the image input process and the facial image of the recognition registrant stored by the facial image storage process;
a restriction cancel process for canceling the restrictions on the predetermined function on the basis of the concordance rate detected by the concordance rate detection process;
a display control process for displaying information concerning the concordance rate detected by the concordance rate detection process concurrently with the facial image of the recognition object person which is input by the image input process.

7. The recognition control method for information processing terminal according to claim 6, wherein
the image input process is an image input process for inputting a facial image of m frames per second,
the concordance rate detection process is a concordance rate detection process for comparing a facial image of the recognition object person of n frames out of the facial image of the recognition object person of m frames per second which is input by the image input process with the facial image of the recognition registrant stored by the facial image storage process and detecting a concordance rate, and
the n is a positive measure of the m.

8. A recognition control program for causing a computer to execute:
a function restriction step of imposing restrictions on a predetermined function;
an image input step of inputting a facial image of a recognition object person;
a facial image storage step of storing a facial image of a recognition registrant;
a concordance rate detection step of detecting a concordance rate between the facial image of the recognition object person which is input at the image input step and the facial image of the recognition registrant stored at the facial image storage step;
a restriction cancel step of canceling the restrictions on the predetermined function on the basis of the concordance rate detected at the concordance rate detection step;
a display control step of displaying information concerning the concordance rate detected at the concordance rate detection step concurrently with the facial image of the recognition object person which is input at the image input step.

9. The recognition control program according to claim 8, wherein
the image input step is an image input step of inputting a facial image of m frames per second,
the concordance rate detection step is a concordance rate detection step of comparing a facial image of the recognition object person of n frames out of the facial image of the recognition object person of m frames per second which is input at the image input step with the facial image of the recognition registrant stored at the facial image storage step and detecting a concordance rate, and
the n is a positive measure of the m.
